(19) United States
(12) Patent Application Publication
(10) Pub. No.: US 2014/0205363 A1
(43) Pub. Date: Jul. 24, 2014

(54) Coupling Device

(71) Applicants: Dennis Ray Fogle, Pella, IA (US); Janet Lea Fogle, Pella, IA (US)

(72) Inventors: Dennis Ray Fogle, Pella, IA (US); Janet Lea Fogle, Pella, IA (US)

(21) Appl. No.: 13/744,947

(22) Filed: Jan. 18, 2013

(51) Int. Cl. F16C 11/04

(52) U.S. Cl. CPC F16C 11/04
USPC 403/61

(57) ABSTRACT

Disclosed is a coupling device. The coupling device may include a first interfacing member, a second interfacing member, and a coupling member connecting the first interfacing member to the second interfacing member. In example embodiments the coupling member may be configured to allow the second interfacing member to translate with respect to the first interfacing member, rotate about first axis, and revolve about a second axis orthogonal to the first axis and the direction of translation.

### BACKGROUND

1. Field

Example embodiments are directed to a coupling device configured to couple a driving member to a driven member. In particular, example embodiments are directed to a coupling device configured to couple the driven member to a front of the driving member.

2. Description of the Related Art

Tractors are robust vehicles capable of pulling and pushing various types of equipment such as mowers, shredders, tillers, and planters. Various types of attachments are used to connect the equipment to the tractor. Some attachments allow the equipment to be substantially free of the tractor itself. That is, some attachments allow the equipment to rotate about various axes while being steerable with the tractor. However, these attachments may be relatively difficult to construct and may require a modification of the tractor in order to attach thereto.

### SUMMARY

Example embodiments are directed to a coupling device configured to couple a driving member to a driven member. In particular, example embodiments are directed to a coupling device configured to couple the driven member to a front of the driving member.

In accordance with example embodiments, a coupling device may include a first interfacing member, a second interfacing member, and a coupling member connecting the first interfacing member to the second interfacing member. In example embodiments the coupling member may be configured to allow the second interfacing member to translate with respect to the first interfacing member, rotate about first axis, and revolve about a second axis orthogonal to the first axis and the direction of translation.

### BRIEF DESCRIPTION OF THE DRAWINGS

Example embodiments are described in detail below with reference to the attached figures, wherein:

FIG. 1 is a perspective view of a coupling device in accordance with example embodiments;

FIG. 2 is an exploded perspective view of a coupling device in accordance with example embodiments;

FIG. 3 is a view of a first interfacing member in accordance with example embodiments;

FIG. 4 is a view of a second interfacing member in accordance with example embodiments;

FIG. 5 is a view of a coupling member in accordance with example embodiments;

FIG. 6 is a view of the coupling device in accordance with example embodiments wherein the second interfacing member is rotated;

FIG. 7 is a view of a the coupling device in accordance with example embodiments wherein the second interfacing member and the coupling member are revolved around an axis line passing through a pin;

FIG. 8 is a view of the coupling device in accordance with example embodiments wherein the second interfacing member and the coupling member are translated with respect to the first interfacing member;

FIG. 9 is a perspective view of a coupling device in accordance with example embodiments;

FIG. 10 is a perspective view of a coupling device in accordance with example embodiments;

FIG. 11 is a perspective view of a coupling device in accordance with example embodiments;

FIGS. 12A-12C are views of a coupling device in accordance with example embodiments;

FIGS. 13A-13C are views of a coupling device in accordance with example embodiments; and

FIGS. 14A-14D are views of a coupling device coupling a driving member to a driven member in accordance with example embodiments.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments are directed to a coupling device configured to couple a driving member to a driven member. In particular, example embodiments are directed to a coupling device configured to couple the driven member to a front of the driving member.

As indicated above, example embodiments relate to a coupling device that may be used to attach a driven member, for example, a mower, to a driving member, for example, a tractor. In example embodiments, the coupling device may be mounted to a front of the driving member. In this arrangement, the driven member may be pushed by the driving member via the coupling device. As will be seen in various nonlimiting example embodiments, the coupling device may include a first interfacing member configured to attach to the driving member, a second interfacing member configured to attach to the driven member, and a coupling member connecting the first interfacing member to the second interfacing member. In example embodiments the coupling member, the first interfacing member, and the second interfacing member may be configured to allow the second interfacing member to translate with respect to the first interfacing member, rotate about a first axis, and revolve about a second axis.

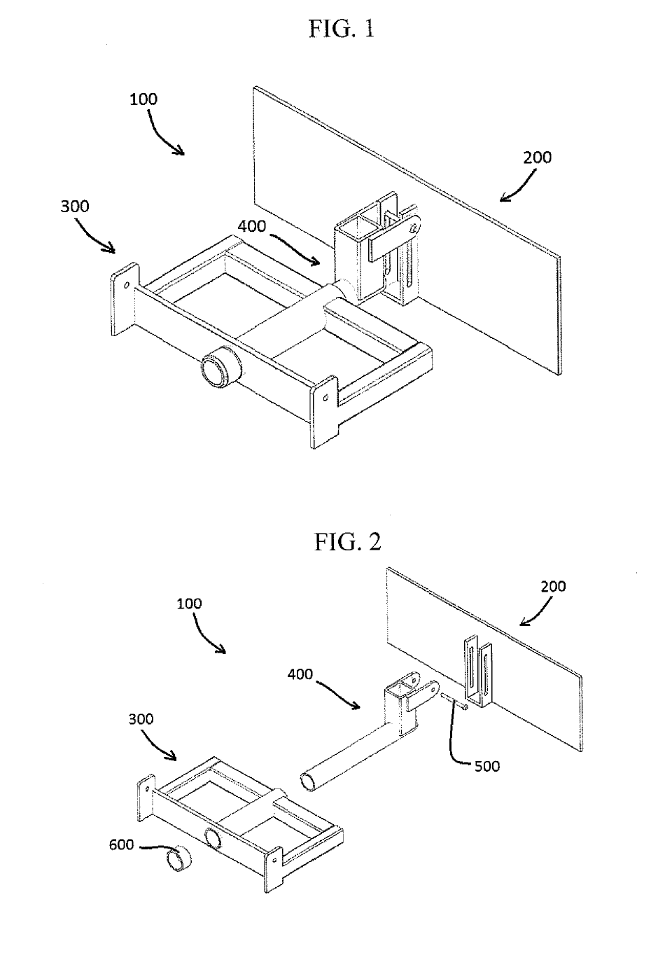

FIGS. 1 and 2, respectively, illustrate a perspective view and an exploded view of a coupling device 100 in accordance with example embodiments. As shown in FIG. 1, the example coupling device 100 may include a first interfacing member 200, a second interfacing member 300, and a coupling member 400 connecting the first interfacing member 200 to the second interfacing member 300. In example embodiments, the coupling device 100 may be configured to attach a driving member, for example, a tractor, to a driven member, for example, a mower. For example, the first interfacing member 200 may be configured to connect to a front of a tractor and the second interfacing member 300 may be configured to connect to a mower. As will be explained shortly, the coupling member 400 may allow the driven member to not only translate with respect to the first interfacing member 200, but rotate about a first axis and revolve about a second axis.

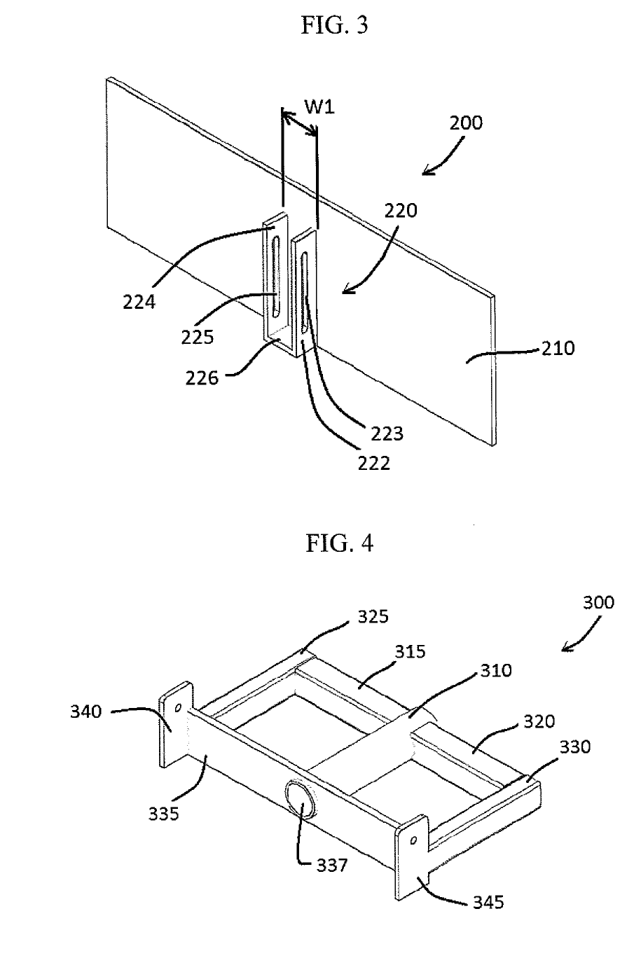

FIG. 3 illustrates an example of the first interfacing member 200 in accordance with example embodiments. As shown in FIG. 2, the first interfacing member 200 may include a first member 210 which may resemble a plate having a substantially constant thickness. The first member 210 may be configured to attach to a front of the driving member. For example, in the event the driving member is a compact tractor with a front end loader, the first member 210 may be configured with members (not shown) that interface with the forks of a front end loader. The instant example, however, is not intended to limit the scope of the invention but is provided merely to provide an example of how the invention may be implemented. For example, the first member 210 may resemble a plate having a variable thickness rather than substantially constant thickness. Furthermore, the first member 210 may be a curved plate rather than a flat plate. Further yet, the first member 210 may be made from a tube rather than plate. Further yet, the first member 210 it may simply be welded to a front of a moving device rather than be being detachably attached thereto.

Referring to FIG. 3, the first interfacing member 200 may further include a bracket 220. The bracket 220, for example, may include a first plate 222 and a second plate 224 which may be parallel with one another. The bracket 220 may also include a third plate 226 arranged near ends of the first plate 222 and the second plate 224. In example embodiments, the first plate 222 may include a slotted hole 223 which may run along a length of the first plate 222. Similarly, the second plate 224 may also include a slotted hole 225 which runs along a length of the second plate 224. In example embodiments, the first and second plates 222 and 224 may be substantially identical to one another. For example, each may have substantially a same length, width, and thickness. Furthermore, the geometric dimensions of their respective slotted holes 223 and 225 may be substantially the same. In example embodiments, the bracket 220 may be attached to the first member 210 by a method such as welding, however, example embodiments are not limited thereto. For example, the bracket 220 may include a back plate (not shown) that may allow the bracket 220 to be bolted to the first member 210. As yet another example, the bracket 220 and the first member 210 may be formed by a casting processing which produces a single integral structure having the bracket 220 and the first member 210.

FIG. 4 is a view of the second interfacing member 300 in accordance with example embodiments. In FIG. 4, the second interfacing member 300 is illustrated as including a sleeve 310. The sleeve 310 may resemble a hollow cylinder through which a portion of the coupling member 400 may be inserted. On a first side of the sleeve 310 is a first extending member 315 and on a second side of the sleeve 310 is a second extending member 320. In example embodiments, the first extending member 315 and the second extending member 320 may be formed from tubular members such as square, rectangular, or circular tube steel. In example embodiments two framing member 325 and 330 may be arranged at either side of the second interfacing member 300. As shown in the figures, the two framing members 325 and 330 may likewise be comprised of tubular members such as square, rectangular, or circular tube steel. In example embodiments, a back plate 335 may extend along a width of the second interfacing member 300 and may include a hole 337 through which a portion of the coupling member 400 may pass. In example embodiments, attachment tabs 340 and 345 may be provided in order to attach the second interfacing member 300 to a driven member. The attachment tabs 340 and 345 may resemble plates with holes cut therethrough to allow the attachment tabs 340 and 345 to be bolted or pinned to the driven member.

The particular description of the second interfacing member 300 described above and shown in the figures is not intended to limit the scope of this invention. For example, in the figures, the first and second extending members are illustrated as being perpendicular to the sleeve 310. However, the first and second extending members 315 and 320 may, alternatively, extend from the sleeve 310 in a skewed manner. As another example, it is not necessary to construct the first and second extending members 315 and 320 or the framing member 325 and 330 as tubes since other sections, such as solid sections, or open sections (such as I-beams or C-beams) may be used instead. In addition, the second interfacing member 300 is not required to have a backplate 335 since another type of structure, for example, a tube, may be used instead. Furthermore, rather than bolting or pinning the second interfacing member to the driven member, the second interfacing member 300 may be welded to the second driving member.

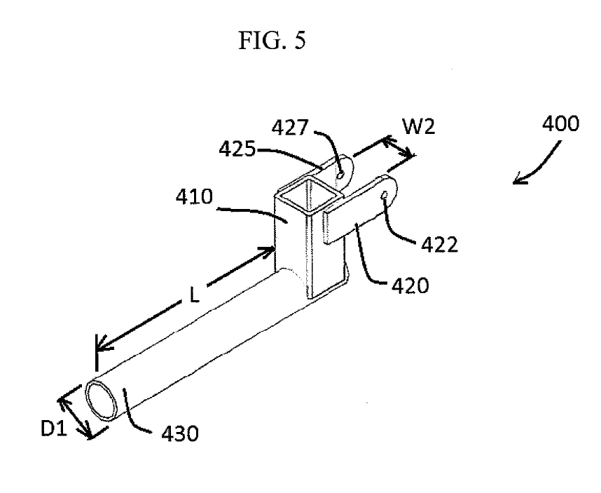

FIG. 5 is a view of the coupling member 400 in accordance with example embodiments. In example embodiments, the coupling member 400 may be comprised of four members. For example, the coupling member 400 may include a main body member 410 to which a cylindrical member 430, a first tab 420, and second tab 425 may attach. In example embodiments, the main body member 410 may be made from a square tube, for example, a 4×4 tube steel member. However, example embodiments are not limited thereto. For example, the main body member 410 may be made from another structure such as a cylindrical tube, a rectangular tube, or an open member such as an I-beam or C-beam. Alternatively, the main body member 410 may be made from a built up member. In addition, rather than forming the main body member 410 from tube, an open member, or a built up member, the main body member 410 may be a solid member.

In example embodiments, the cylindrical member 430 may extend from the main body member 410. The cylindrical member 430, for example, may have a diameter D1 which is about the same as, or smaller than, an inner diameter of the sleeve 310 of the second interfacing member 300. Thus, the cylindrical member 430 of the coupling member 400 may be inserted into the sleeve 310 of the second interfacing member 300. Furthermore, since the inner diameter of the sleeve 310 may be about the same as, or larger than the diameter D1 of the cylindrical member 430 the second interfacing member 300 may rotate about an axis defined by the cylindrical member 430. In example embodiments, a length of the cylindrical member 430 is long enough to allow an end of the cylindrical member 430 to extend through the sleeve 310 and through the hole 337 of the back plate 335. This end may be connected to a collar 600 (see FIG. 2) which may secure the cylindrical member 430 in place. The collar 600, for example, may be a short cylinder having an inner diameter large enough to allow the diameter D1 of the cylindrical member 430 to pass therein and an outer diameter larger than the hole 337 of the backplate 335. In example embodiments, the cylindrical member 430 may be welded to the collar 600 to prevent the cylindrical member 430 from backing through the sleeve 310. In the alternative, an end of the cylindrical member 430 may be threaded and an inside surface of the collar 600 may be threaded in a manner that allows the collar to be screwed onto the cylindrical member 430. As yet another example, the collar 600 may be attached to the cylindrical member 430 by a pin type connection.

Referring back to FIG. 5, and as mentioned above, the coupling member 400 may additionally include a first tab 420 and a second tab 425. As shown in at least FIG. 5, each of the first and second tabs 420 and 425 may resemble a flat plate having a hole at one end. For example, the first tab 420 may have a first hole 422 and the second tab 425 may have a second hole 427. The diameters of the first and second holes 422 and 427 may be about the same size, or larger than a diameter of a pin 500 (see FIG. 2) which may pass through the first and second holes 422 and 427. In example embodiments, a diameter of the first and second holes 422 and 427 may be about the same as the widths of the slotted holes 223 and 224 of the bracket 220.

As shown in FIG. 5, the first tab 420 may be attached to a first side of the main body member 410 and the second tab 425 may be attached to a second side of the main body member 410. In example embodiments, inside surfaces of the first tab 420 and the second tab 425 may be spaced at a distance W2 which is about the same as, or larger than, the width W1 of the bracket. Thus, when assembled, the bracket 220 may fit between the first and second tabs 420 and 425.

In example embodiments, the coupling member 400 may be attached to the bracket 220 by the pin 500. The pin 500, for example, may be inserted through the first hole 422 of the first tab 420, through the first slotted hole 223 of the bracket 220, through the second slotted hole 225 of the bracket 220, and through the second hole 427 of the second tab 425. The pin 500 may be secured in place either through another pin or a nut in the event pin 500 has a threaded end. In the alternative, the pin 500 may be held in place by simply welding the pin 500 to the either one of the first tab 420 and the second tab 425.

In example embodiments, because the widths of the first and second slotted holes 223 and 225 are larger than the diameter of the pin 500, the pin 500 may translate along the slots 223 and 225. In addition, because the widths of the first and second slotted holes 223 and 225 are larger than diameter of the pin 500, the pin 500 may also rotate within the first and second slotted holes 223 and 225. By nature of this type of connection, the coupling member 400 may both revolve about an axis defined by the pin 500 and move along the slotted holes 223 and 225 of the bracket 220 allowing it to translate and revolve with respect to the first interfacing member 200.

Thus far, FIGS. 1-5 provide an example of a coupling device 100 in accordance with example embodiments. As described, the coupling device 100 includes a first interfacing member 200, a second interfacing member 300, and coupling member 400 connecting the first interfacing member 200 to the second interfacing member 300. In example embodiments, the coupling member 400 provides a first axis (defined by the cylindrical member 430) about with the second interfacing member 300 may rotate, a second axis (defined by the pin 500) about which the second interfacing member 300 may revolve. In addition, due to the holes 223 and 225 being slotted, and due to the limitation that the pin 500 has a diameter which is the about the same as, or smaller than the widths of the slotted holes 223 and 225, the pin 500 may translate along the slotted holes thus allowing the coupling member 400 and the second interfacing member 300 to translate with respect to the first interfacing member 200.

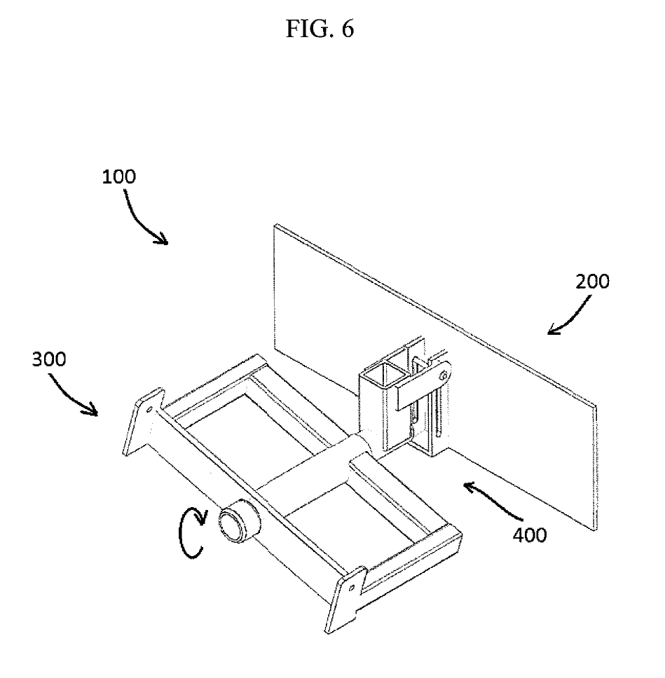

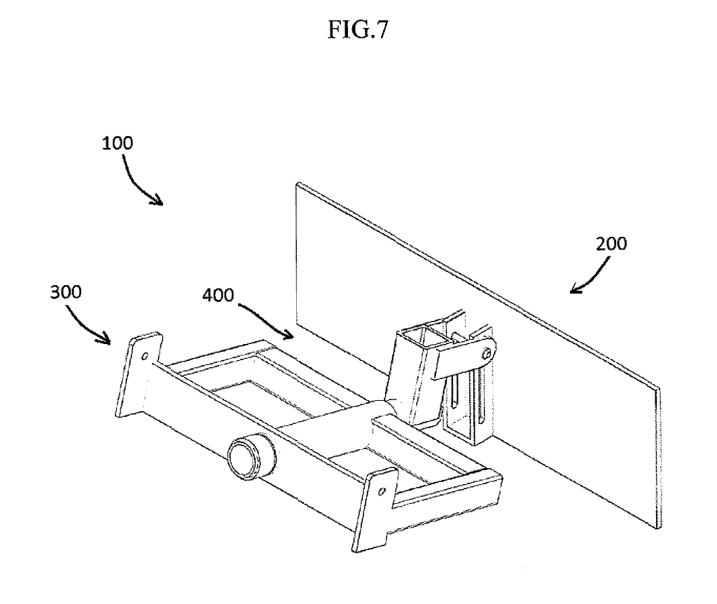

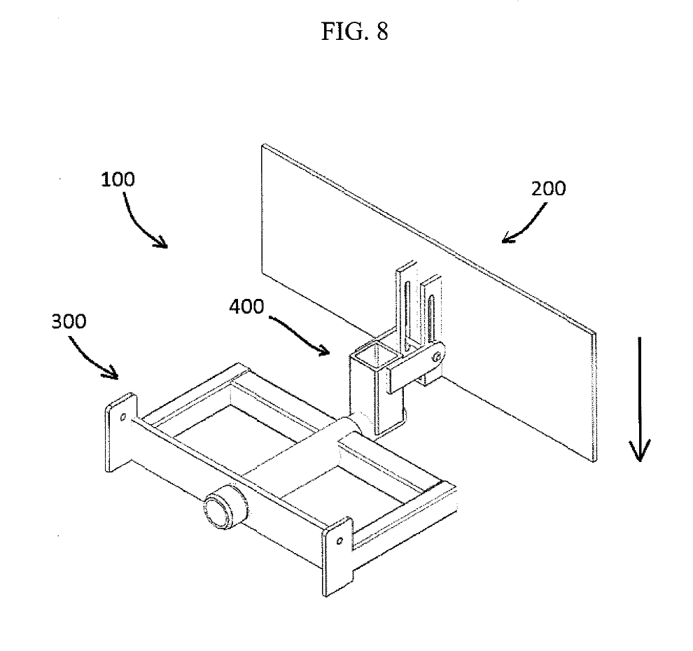

FIGS. 6-8 illustrate various configurations of the coupling device 100 in accordance with example embodiments. FIG. 6, for example, illustrates the second interfacing member 300 rotating about the cylindrical member 430 of the coupling member 400. Thus, FIG. 6 provides an example illustration of the second interfacing member 300 rotating with respect to the first interfacing member 200. FIG. 7 illustrates the second interfacing member 300 revolving about the pin 500. FIG. 8, illustrates the second interfacing member 300 translating with respect to the first interfacing member 200 by moving the pin 500 down the slotted holes 223 and 225.

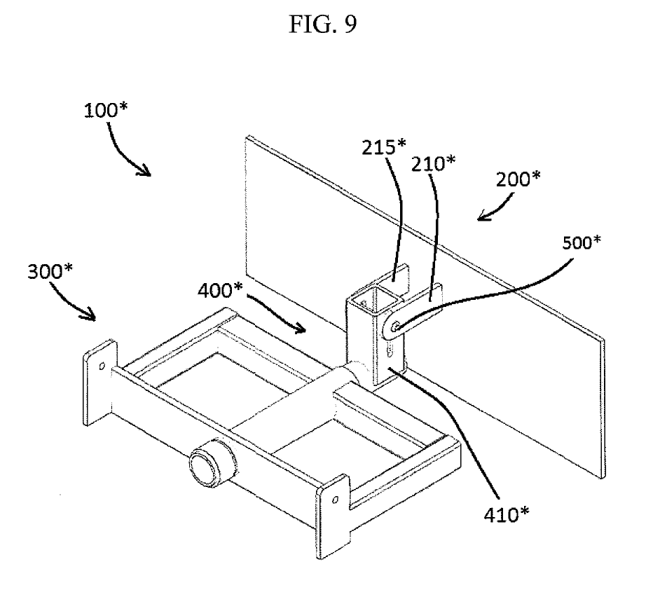

FIG. 9 is another example of a coupling device 100* in accordance with example embodiments. The coupling device 100* may be similar to the previously described coupling device 100, thus, only the differences will be pointed out for the sake of brevity.

Referring to FIG. 9, the coupling device 100* may include a first interfacing member 200*, a second interfacing member 300*, and a coupling member 400*. The first interfacing member 200*, as shown in FIG. 9, may be substantially the same as the first interfacing member 200 except that the first interfacing member 200* does not include a bracket 220. Rather, a pair of tabs 210* and 215* are provided instead. The pair of tabs 210* and 215* may resemble substantially flat plates. In example embodiments, the pair of tabs 210* and 215* may be arranged parallel with each other as shown in FIG. 9. In example embodiments, each of the pair of tabs 210* and 215* may include a hole through which a pin 500* may pass.

In example embodiments, the coupling member 400* may be substantially the same as the previously described coupling member 400 except that the coupling member 400* does not have the pair of tabs 420 and 425. In addition, sides of the main body 410* of the coupling member 400* may be slotted. In example embodiments, the pin 500* may traverse a width of the body 410* as well as widths of the pair of tabs 210* and 215* and may be secured in place by a nut, a pin, or by welding as was previously described. In example embodiments, the slots in the main member 410* may allow the pin 500* to not only rotate but translate. Thus, the degrees of freedom associated with the coupling device 100* are substantially the same as the degrees of freedom associated with the coupling device 100.

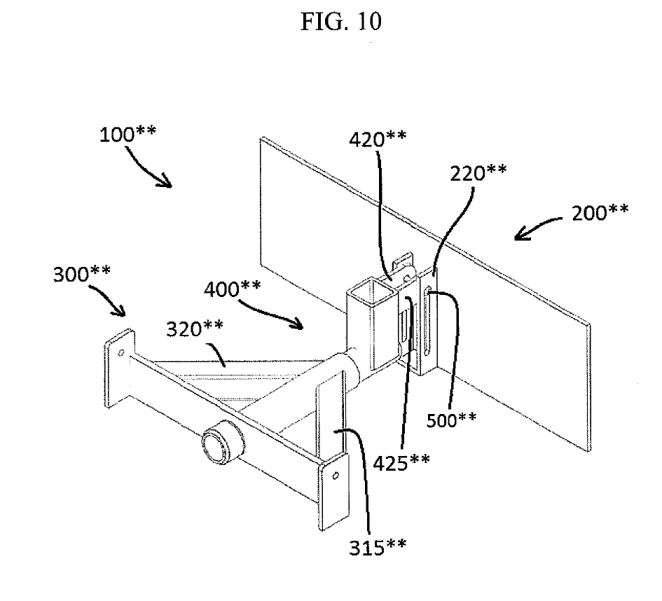

FIG. 10 is another example of a coupling device 100** in accordance with example embodiments. The coupling device 100** may be similar to the previously described coupling device 100, thus, only the differences will be pointed out for the sake of brevity.

Referring to FIG. 10, the coupling device 100** may include a first interfacing member 200**, a second interfacing member 300**, and a coupling member 400**. The first interfacing member 200**, as shown in FIG. 10, may be substantially the same as the first interfacing member 200.

In example embodiments, the coupling member 400** may be substantially the same as the previously described coupling member 400 except that the coupling member 400** has a pair of tabs 420** and 425** arranged to fit inside the bracket 220** rather than as tabs designed to sandwich the bracket 220**. The pair of tabs 420** and 425** may be welded on a side of the coupling member 400* as shown in FIG. 10 or may be formed integral with a body of the coupling member 400** as in a casting process. In example embodiments, the pair of tabs 420** and 425** may include holes through which a pin 500** may pass to allow the coupling member 400** to not only rotate but translate. Thus, the degrees of freedom associated with the coupling device 100** are substantially the same as the degrees of freedom associated with the coupling device 100.

In example embodiments, the second interfacing member 300** is formed with a first extending member 315** and a second extending member 320** attached to different sides of a cylindrical member. Unlike the first and second extending members 315 and 320 of the second interfacing member 300 of the coupling device 100, the first and second extending members 315** and 320** extend from the cylindrical member in a skewed manner towards a backplate of the second interfacing member 300**. As in the previous example, the second interfacing member 300** of the coupling device 100** includes attachment tabs suitable for connecting the second interfacing member 300** to a driven member.

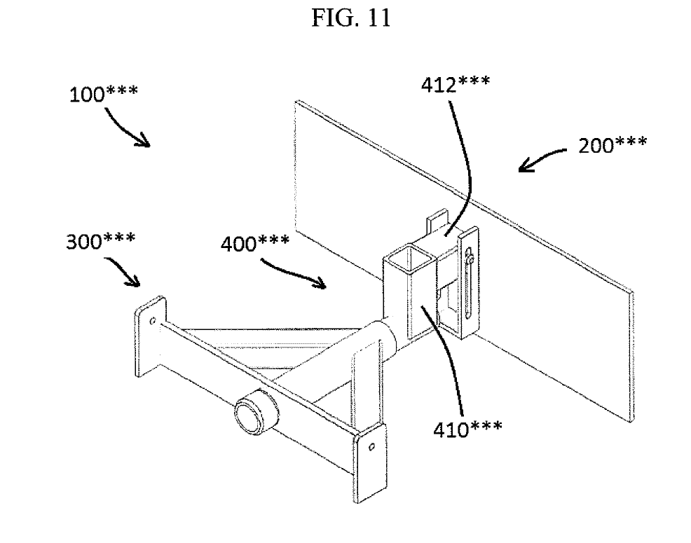

FIG. 11 is another example of a coupling device 100*** in accordance with example embodiments. The coupling device 100*** may be similar to the previously described coupling device 100 except that a piece of tube steel 410***, rather than a pair of tabs, is used to connect the coupling member 400*** to a first interfacing member 200***.

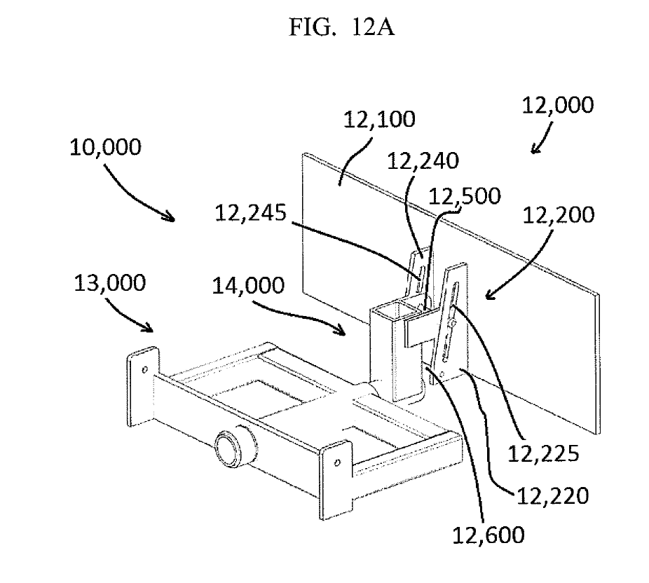

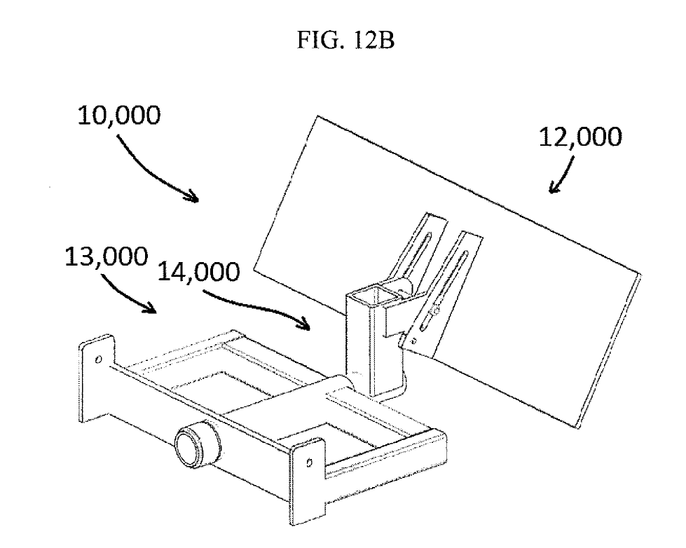

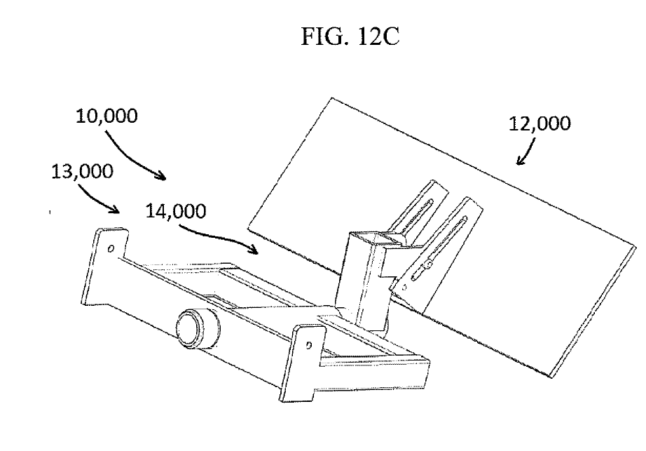

FIGS. 12A-12C illustrate another example of a coupling device 10,000 in accordance with example embodiments. In example embodiments, the coupling device 10,000 may include a first interfacing member 12,000, a second interfacing member 13,000, and a coupling member 14,000. In example embodiments, the second interfacing member 13,000 and the coupling member 14,000 may be similar to the earlier described second interfacing member 300 and the earlier described coupling member 400 of FIGS. 1-8, thus a detailed description thereof is omitted for the sake of brevity.

Referring to FIGS. 12A-12C, the first interfacing member 12,000 may include a first member 12,100 and a bracket 12,200. The first member 12,100 may be similar to the first member 210 illustrated in FIGS. 1-8 and described above. Thus a detailed description thereof will be omitted for the sake of brevity. The bracket 12,200 may be similar to the bracket 220 illustrated in FIGS. 1-8 and described above, except that in example embodiments, the bracket 12,200 may include a first plate 12,220 having a first slotted hole 12,225 and a second plate 12,240 having a second slotted hole 12,245, wherein the first and second slotted holes 12,225 and 12,245 are inclined as shown in FIGS. 12A-12C. In example embodiments, a pin 12,500 may be used to connect the coupling member 14,000 to the first interfacing member 12,000. In example embodiments, a diameter of the pin 12,500 may be about the same size as, or slightly smaller than a width of the slotted holes 12,225 and 12,245. Thus, the pin may be able to translate along the slotted holes 12,225 and 12,245 as well as rotate within the slotted holes 12,225 and 12,245. Because the slotted holes 12,225 and 12,245 are inclined the second interfacing member 13,000 and the coupling member 14,000 may move away from the first interfacing member 12,000 as the pin 12,500 moves along the slotted holes 12,225 and 12,245.

In example embodiments a stop member 12,600 may be incorporated into the bracket 12,200. The stop member 12,600 may provide an abutment surface for the main body member of the coupling member 14,000 to bear against. For example, if the first member 12,100 is rotated backwards as shown in FIGS. 12B and 12C, the main body member of the coupling member 14,000 may bear against the stop member 12,600 thus preventing further rotation of the coupling member 14,000 with respect to the first interfacing member 12,000. Thus, if the first interfacing member 12,000 is further rotated, each of the coupling member 14,000, the second interfacing member 13,000, and any equipment attached to the second interfacing member 13,000 would rotate along with the first interfacing member 12,000. This aspect of example embodiments allows for equipment attached to the second interfacing member 13,000 to be lifted off the ground.

In example embodiments the stop member 12,600 may resemble a pin or a bar which may pass through each of the first plate 12,220 and the second plate 12,240 as shown in FIGS. 12A-12C. Example embodiments, however, are not limited thereto. For example, rather than providing the stop member 12,600 as a pin or a bar, the stop member 12,600 may be a bumper attached to the first member 12,100 or a bumper attached to the bracket 12,220. As would be obvious to one skilled in the art, the bracket 200 illustrated in FIGS. 1-8 may be modified to include a stop member (or other structure such as the bumpers) in a manner similar to that shown in FIGS. 12A-12C or described above.

It is noted the coupling devices of example embodiments is not required to have a stop member in the form of a pin or a bumper. For example, the brackets themselves may serve as stop members or the first members (for example, the first member 210) may serve as a stop member. In these latter cases, the coupling devices may be configured such that a portion of the coupling members may contact a portion of the first interfacing members in a manner that prevents the coupling member from rotating with respect to the first interfacing member.

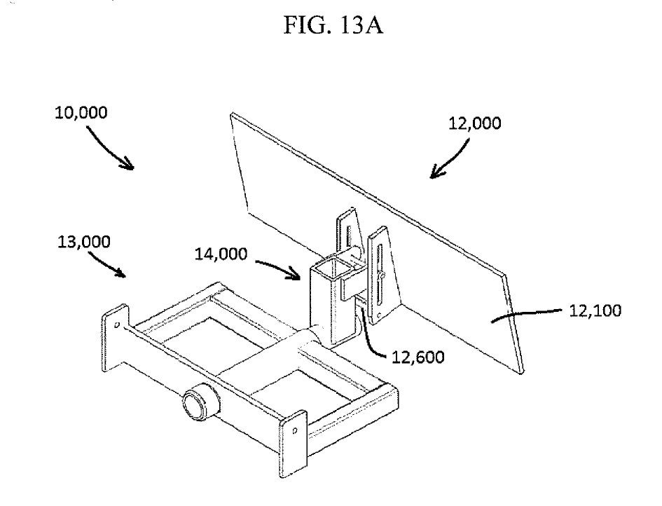

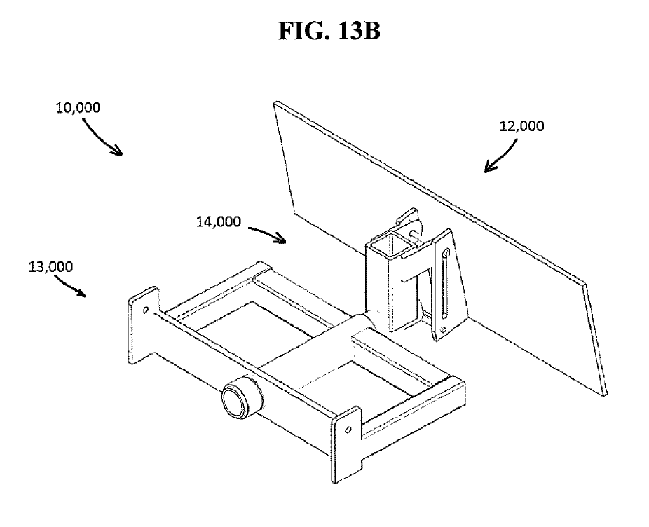

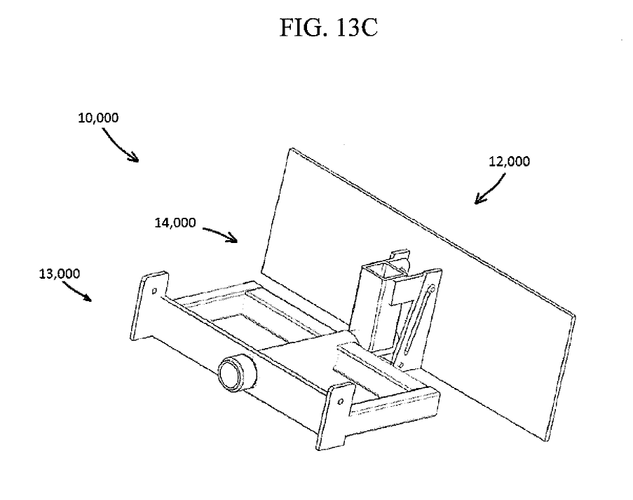

FIGS. 13A-13C illustrate additional kinematics associated with the coupling device 10,000. As explained above, the bracket 12,200 may include a pair of slots 12,225 and 12,245 that may be inclined (with respect to the first member 12,100). In example embodiments, the inclined slots 12,225 and 12,245 may be made vertical by simply rotating the first member 12,100 forward as shown in FIG. 13A. In this configuration, the second interfacing member 13,000 and the coupling member 14,000 may be substantially free to move vertically. FIG. 13B illustrates the first member 12,100 of the first interfacing member 12,000 moved downwards (with respect to the second interfacing member 13,000 and the coupling member 14,000) so that the pin 12,500 is near or at tops of the slotted holes 12,225 and 12,245. In example embodiments, the bracket 12,200 may be configured such that the stop member 12,600 is near or below the cylindrical portion of the coupling member 14,000 when the pin 12,500 is near or at the tops of the slotted holes 12,225 and 12,245. Thus, as shown in FIG. 13C, when the first member 12,100 is rotated backwards, the stop member 12,600 may be under the cylindrical member of the coupling member 14,000 (as shown in FIGS. 13B and 13C) or may directly face the cylindrical member of the coupling member 14,000. Further rotation of the first member 12,100 would cause the coupling member 14,000 and the second interfacing member 13,000 to move with the first interfacing member 12,000 as the first interfacing member 12,000 is further rotated (see FIG. 13C).

Thus far, example embodiments provide a coupling device 100, 100*, 100**, 100***, and 10,000 that may be usable to attach a driving member to a driven member. In example embodiments, the coupling device 100, 100*, 100**, 100***, 10,000 may include a first interfacing member 200, 200*, 200**, 200**, and 12,100 configured to connect to a driving member and a second interfacing member 300, 300*, 300**, 300***, and 13,000 configured to connect to a driven member. The coupling device 100, 100*, 100**, 100***, and 10,000 may include a coupling member 400, 400*, 400**, 400***, and 14,000 to connect the first interfacing member 200, 200*, 200**, 200***, and 12,100 to the second interfacing member 300, 300*, 300**, 300***, and 13,000. Connecting structures 420, 425, 210*, 215*, 420**, 425**, and 412*** may be used to connect the coupling member 400, 400*, 400**, 400***, and 14,000 to the first interfacing member 200, 200*, 200**, 200***, and 12,100.

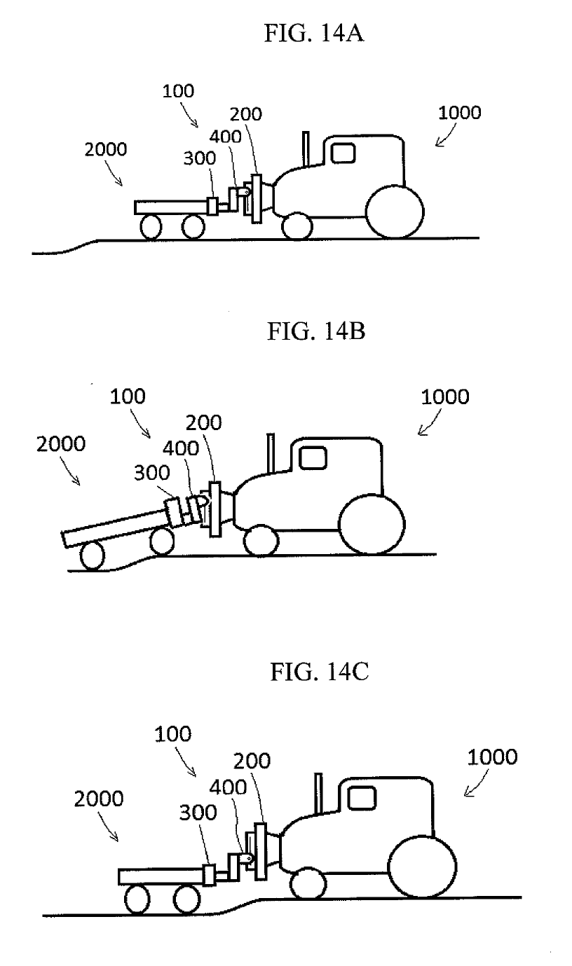

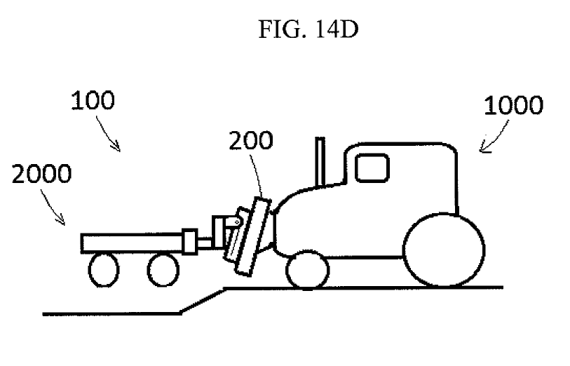

FIGS. 14A-14D illustrate an example of the coupling device 100 attached to a front end of a tractor 1000 (an example of a driving member) and a back end of a mower 2000 (an example of a driven device). More specifically, the first interfacing member 200 is attached to a front end of the tractor 1000 and the second interfacing member 300 is attached to a back end of the mower 2000. Though a tractor 1000 and a mower 2000 are used in this example, the tractor 1000 and the mower 2000 are not meant to limit example embodiments as the driving member may be another kind of member such as, but not limited to, a truck, a car, a forklift, or a boat and the mower may be another kind of driven device such as, but not limited to, a skid, a planter, or a boat.

Referring to FIGS. 14A-14D it is observed that the tractor 1000 may push the mower 2000 on a same plane as shown in FIG. 14A. In the event the plane on which the tractor 1000 and mower 2000 is disrupted by a bump or a curb so as to form a second plane having a different elevation, it is observed that the coupling device 100 allows the mower 2000 to rotate with respect to the tractor 1000 as shown in FIG. 14B as the mower 2000 passes over the discontinuity. During the rotation of the mower 2000 the pin 600 is allowed to slide in the slots 223 and 225 thus allowing the mower 2000 to move to a different elevation and realign itself with the tractor 1000 as shown in FIG. 14C. In example embodiments, the mower 2000 may be lifted off the ground by rotating the first member 210 of the first interfacing member 200 as shown in FIG. 14D. As shown in FIG. 14D, and as understood by one skilled in the art, if the first member 210 is rotated far enough, a portion of the coupling member 400, for example, the main body member 410, may interfere (contact or press against) with the first member 210 or the bracket 220 of the first interfacing member 200 (or a stopping member 12,600 as shown in FIGS. 12A-12C). This interference has the advantage of providing a force-couple which allows the mower 2000 to be lifted off the ground as shown in FIG. 14D.

Example embodiments are not intended to be limited by the operations and configurations of FIGS. 14A-14D. For example, in the event the coupling device 10,000 is used to connect the tractor 1000 to the mower 2000, the first member 12,100 of the coupling device 10,000 may be rotated forwards so that the slotted holes 12,225 and 12,245 are substantially vertical while the mower 2000 is being pushed by the tractor 1000. This would allow the mower 2000 to move vertically without imparting significant stress to the tractor 1000. As above, the mower 2000 may be lifted up by rotating first member 12,100 backwards or by moving the first member 12,100 down so that the pin 12,500 is arranged near or at the tops of the slotted holes 12,245 and 12,245 and then rotating the first member 12,100 backwards.

While example embodiments have been particularly shown and described with reference to example embodiments thereof, it will be understood by those of ordinary skill in the art that various changes in form and details may be made therein without departing from the spirit and scope of the invention.

What we claim is:

1. A coupling device comprising:
a first interfacing member;
a second interfacing member; and
a coupling member connecting the first interfacing member to the second interfacing member, the coupling member being configured to allow the second interfacing member to translate with respect to the first interfacing member, rotate about first axis, and revolve about a second axis orthogonal to the first axis and the direction of translation.

2. The coupling device according to claim 1, wherein the coupling member includes a cylindrical member defining the first axis.

3. The coupling device according to claim 2, wherein the second interfacing member includes a sleeve through which the cylindrical member passes.

4. The coupling device according to claim 1, wherein one of the first interfacing member and the coupling member includes a slotted member.

5. The coupling device according to claim 4, further comprising:
a pin passing through the slotted member, wherein the pin is configured to translate along the slotted member.

6. The coupling device according to claim 5, further comprising:
a connecting structure attached to one of the coupling member and the first interfacing member, wherein the pin extends through a hole in the connecting structure.

7. The coupling device according to claim 6, wherein the coupling member includes a main body and the connecting structure is a pair of tabs attached to the main body.

8. The coupling device according to claim 7, wherein the first interfacing structure includes the slotted member.

9. The coupling device according to claim 8, wherein
the coupling member includes a cylindrical member having a centerline about which the second interfacing member rotates and the connecting structure is a pair of tabs attached to the coupling member.

10. The coupling device according to claim 6, wherein the coupling member includes the slotted member and the connecting structure is a pair of tabs attached to the first interfacing member.
